(19) United States
(12) Patent Application Publication
(10) Pub. No.: US 2026/0148357 A1
(43) Pub. Date: May 28, 2026

(54) FAULT DETECTION FOR HEADS-UP DISPLAY

(71) Applicant: Renesas Electronics America Inc., Milpitas, CA (US)

(72) Inventors: Li-Herng YAO, San Ramon, CA (US); Jayant Padmakar VIVREKAR, San Jose, CA (US); Hyoungyon Han, San Jose, CA (US)

(73) Assignee: Renesas Electronics America Inc., Milpitas, CA (US)

(21) Appl. No.: 18/990,628

(22) Filed: Dec. 20, 2024

Related U.S. Application Data
(60) Provisional application No. 63/725,842, filed on Nov. 27, 2024.

(51) Int. Cl. G06T 7/00; B60K 35/23; B60K 35/90

(52) U.S. Cl. CPC G06T 7/0002; B60K 35/23; B60K 35/90; G06T 2207/10024; G06T 2207/30168; G06T 2207/30248

(57) ABSTRACT

Systems and methods for fault detection in heads-up display are described. A processor can receive an image signal encoding image data of a virtual image to be projected on a surface of a windshield of a vehicle. The processor can select a group of pixels corresponding to a region of the virtual image. The processor can determine at least one characteristic for each pixel in the group of pixels. The processor can determine one or more group attributes representative of the group of pixels based on the at least one characteristic for each pixel in the group of pixels. The processor can determine that the one or more group attributes fails to satisfy a condition associated with a set of predefined threshold group attributes. The processor can, in response to determining that the one or more group attributes fails to satisfy the condition, generate a fault detection signal.

### CROSS-REFERENCE TO RELATED APPLICATION

This application claims the benefit of U.S. Provisional Application No. 63/725,842 filed on Nov. 27, 2024. The entire content of U.S. Provisional Application No. 63/725,842 is incorporated herein by reference.

### BACKGROUND

The present disclosure relates in general to systems and methods for fault detection for heads-up displays (HUDs), particularly, fault detection for augmented reality (AR) projections on HUDs of vehicles.

A vehicle can utilize remote sensing technologies to obtain information about objects in the vehicle's surroundings. The remote sensing technologies can include, for example, lasers, sonar, radar, cameras, and other sensors and devices that scan and record data from the vehicle's surroundings. The obtained information can be used for decision making by an operator of the vehicle and/or by computers in the vehicle. In an aspect, the obtain information can be processed by computers in the vehicles to generate virtual images. The generated virtual images can be projected onto a heads-up display (HUD) on a surface to display augmented reality (AR) objects that overlay with a real world field of view of the operator. The surface can be, for example, a windshield or other transparent surface that may be in the operator's line of sight. The displayed AR objects can facilitate safety and road awareness. For example, the displayed AR objects on the HUD can be real time driving directions and information that can improve navigation and driver experience. To maintain safety, it is desirable to display the AR objects on the surface while maintaining direct vision of the road, such as ensuring that the displayed AR objects do not obstruct the vehicle operator viewing of physical objects in the surroundings.

### SUMMARY

In one embodiment, a method for fault detection in heads-up display systems is generally described. The method can include receiving, by a processor, an image signal encoding image data of a virtual image to be projected on a surface of a windshield of a vehicle. The method can further include selecting, by the processor, a group of pixels corresponding to a region of the virtual image. The method can further include determining, by the processor, at least one characteristic for each pixel in the group of pixels. The method can further include determining, by the processor, one or more group attributes representative of the group of pixels based on the at least one characteristic for each pixel in the group of pixels. The method can further include determining, by the processor, that the one or more group attributes fails to satisfy a condition associated with a set of predefined threshold group attributes. The method can further include, in response to determining that the one or more group attributes fails to satisfy the condition, generating, by the processor, a fault detection signal.

In one embodiment, a system for fault detection in heads-up display is generally described. The system can include a memory and a processor. The memory can be configured to store a condition associated with a set of predefined threshold group attributes. The processor can be configured to receive an image signal encoding image data of a virtual image to be projected on a surface of a windshield of a vehicle. The processor can be further configured to select a group of pixels from the image signal. The processor can be further configured to determine at least one characteristic for each pixel in the group of pixels. The processor can be further configured to determine one or more group attributes representative of the group of pixels based on the at least one characteristic for each pixel in the group of pixels. The processor can be further configured to determine whether the one or more group attributes satisfy a condition associated with a set of predefined threshold group attributes. The processor can be further configured to, in response to determination that the one or more group attributes fails to satisfy the condition, generate a fault detection signal.

In one embodiment, a system for fault detection in heads-up display is generally described. The system can include a graphic processing unit (GPU), a surface, a projector, and a processor. The GPU can be configured to generate image signal encoding image data of a virtual image. The projector can be configured to project the virtual image on the surface. The processor can be configured to receive the image signal from the GPU. The processor can be further configured to select a group of pixels from the image signal. The processor can be further configured to determine at least one characteristic for each pixel in the group of pixels. The processor can be further configured to determine one or more group attributes representative of the group of pixels based on the at least one characteristic for each pixel in the group of pixels. The processor can be further configured to determine whether the one or more group attributes satisfy a condition associated with a set of predefined threshold group attributes. The processor can be further configured to, in response to determination that the one or more group attributes fails to satisfy the condition, generate a fault detection signal.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1A is a diagram showing an example system that can implement fault detection for heads-up display in one embodiment.

FIG. 1B is a diagram showing an example heads-up display that can implement fault detection for heads-up display in one embodiment.

FIG. 2A is a diagram showing an example implementation of fault detection for heads-up display in one embodiment.

FIG. 2B is a diagram showing a plurality of individual regions within an augmented reality section of a heads-up display in one embodiment.

FIG. 3A is a diagram showing a plurality of regions of an example augmented reality object that can be used in an implementation of fault detection for heads-up display in one embodiment.

FIG. 3B is a diagram showing pixel distribution of a first example region of the example augmented reality object of FIG. 3A in one embodiment.

FIG. 3C is a diagram showing pixel distribution of a second example region of the example augmented reality object of FIG. 3A in one embodiment.

FIG. 4A is a diagram showing a probability distribution of pixels before an equalization in an implementation of fault detection for heads-up display in one embodiment.

FIG. 4B is a diagram showing a probability distribution of pixels after an equalization in an implementation of fault detection for heads-up display in one embodiment.

FIG. 5A is a diagram showing a first example equalization that can be used in an implementation of fault detection for heads-up display in one embodiment.

FIG. 5B is a diagram showing a second example equalization that can be used in an implementation of fault detection for heads-up display in one embodiment.

FIG. 6 is a flowchart of an example process that can implement fault detection for heads-up display in one embodiment.

### DETAILED DESCRIPTION

In the following description, numerous specific details are set forth, such as particular structures, components, materials, dimensions, processing steps and techniques, to provide an understanding of the various embodiments of the present application. However, it will be appreciated by one of ordinary skill in the art that the various embodiments of the present application may be practiced without these specific details. In other instances, various structures or processing steps have not been described in detail to avoid obscuring the present application.

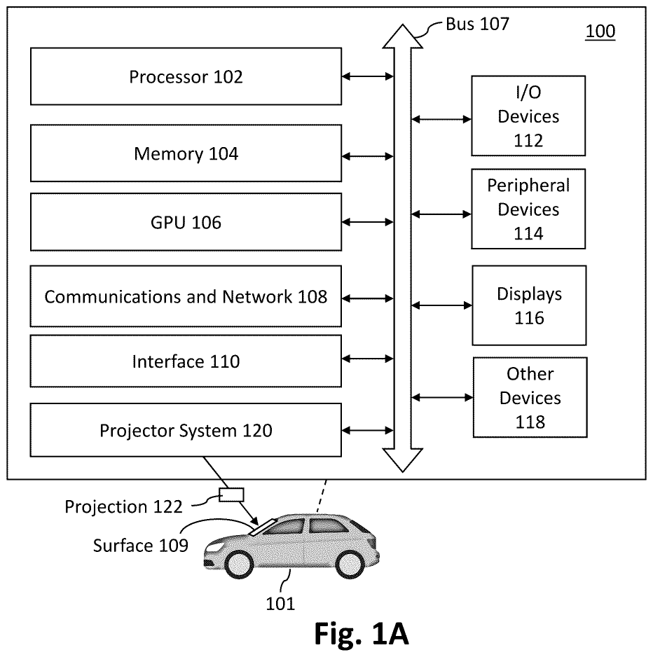

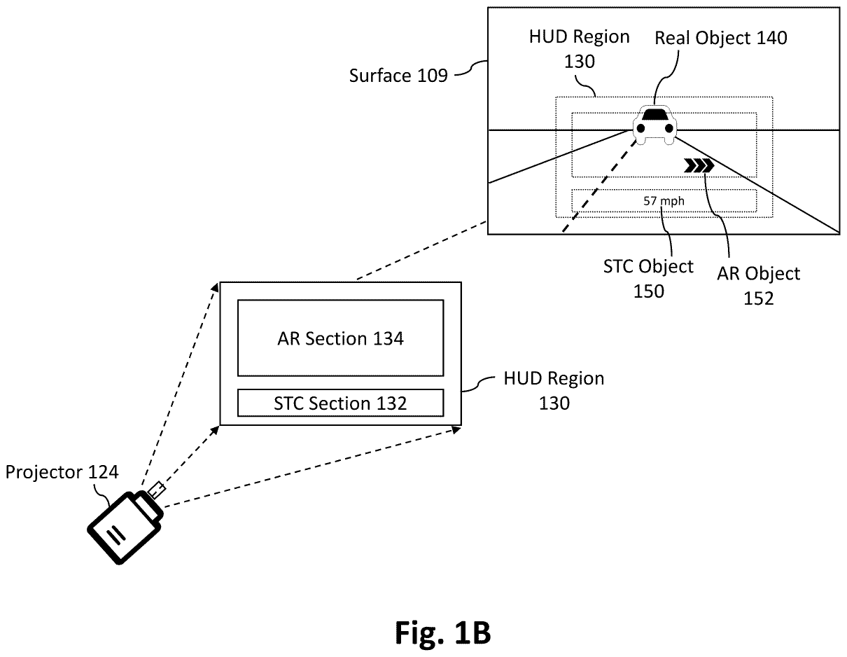

FIG. 1A is a diagram showing an example system that can implement fault detection for heads-up display in one embodiment. System 100 can be implemented in a vehicle 101. The vehicle 101 can be a vehicle that can be operated by an operator, an autonomous vehicle, or an autonomous vehicle with an option to be operated by an operator. In one embodiment, system 100 can be a system on a chip (SoC), where an SoC can be an integrated circuit that integrates various computing and electronic components or modules on a single chip. Components that can be integrated on a single chip to produce an SoC can include, but not limited to, a central processing unit (CPU), processor cores, microcontrollers, microprocessors, peripherals (e.g., graphics processing unit (GPU), graphics and memory interfaces, functional circuit blocks for processing digital, analog, mixed-signal, etc.

In the example shown in FIG. 1, system 100 can include a processor 102, a memory 104, a graphics processing unit (GPU) 106, a communication bus 107 (bus “107”), a communication and network module 108, an interface module 110, and a projector system 120. The components of system 100 shown in FIG. 1 is one example embodiment, and system 100 can include components or modules that may not be shown in the example in FIG. 1. For example, in one or more embodiments, system 100 can include timing sources (e.g., crystal oscillators and phase-locked loops), SoC peripherals (e.g., counter-timers, real-time timers and power-on reset generators), voltage regulators, power management circuits, etc.

Processor 102 can be, for example, a central processing unit (CPU) or a processor core in a microcontroller or a microprocessor, an application-specific instruction set processor (ASIP), and/or other types of processing elements. Memory 104 can include one or more memory devices including storage elements such as, for example, read-only memory (ROM), random-access memory (RAM) including static RAM (SRAM) and/or dynamic RAM (DRAM), electrically erasable programmable ROM (EEPROM), flash memory, registers, caches, and/or other types or memory or storage elements.

GPU 106 can include various hardware components specifically for processing image and/or video data, and image rendering. For example, GPU 106 can include video codec processors, three-dimensional (3D) graphics processors, video signal processor, image renderer, machine learning components such as computer vision and deep learning accelerators, etc. GPU 106 can be configured to generate image data of virtual images that can be projected onto a surface of vehicle 101 (described below) to display AR objects. By way of example, GPU 106 can encode image data, such as shape, size, dimension, boundaries, pixel values, intensity, brightness, luminance, or other image attributes, in a digital image signal.

Communication bus 107 can be a digital data bus that allows data and instructions to be exchanged between different modules within system 100. Various data bus architectures, or sparse intercommunication networks known as networks-on-chip (NoC), can also be implemented in system 100. Bus 107 can also allow routing of data directly between external interfaces among interface 110 and memory 104 while bypassing processor 102 to increase data throughput of system 100.

Interface 110 can include interfaces for various different communication protocols, such as, for example, camera serial interface (CSI), universal serial bus (USB), FireWire, Ethernet, universal synchronous and asynchronous receiver-transmitter (USART), Serial Peripheral Interface (SPI), Mobile Industry Processor Interface (MIPI), Low Voltage Differential Signaling (LVDS) interface, High-Definition Multimedia (HDMI) interface, Inter-Integrated Circuit (I²C), interfaces that support wireless communication protocols such as Wi-Fi, Bluetooth, near-field communication, etc. Interface 110 can also include analog interfaces, such as analog-to-digital converters (ADC) and digital-to-analog converters (DAC), to interface with different types of sensors or actuators, including smart transducers.

System 100 can interface with various components in vehicle 101 via interface 110. In the example shown in FIG. 1, system 100 can interface with displays 116. Displays 116 can include, for example, a liquid crystal display thin-film transistor (LCD-TFT) screen, a light-emitting diode (LED) screen, an organic light-emitting diode (OLED) screen, a touch screen display, and/or other types of display suitable for vehicles.

GPU 106, projector system 120 and a surface 109 of vehicle collectively can form a heads-up display (HUD) system. In one embodiment, surface 109 can be a HUD-enabled windshield, which can be the windshield of vehicle 101 coated with a specialized compound containing nanophosphors to allow the windshield of vehicle 101 to be used as a transparent screen. A surface for displaying AR objects in a HUD system can sometimes be referred to as a combiner. Projector system 120 can be an optical collimator system including various components such as a convex lens or concave mirror with a cathode-ray tube, light emitting diode display, or liquid crystal display at its focus. GPU 106 can be configured to generate image data of virtual images that can be projected by projector system 120 on surface 109 to display AR objects. GPU 106 can encode the generated image data in a digital image signal, and send the digital image signal to projector system 120. Projector system 120 can perform a projection 122 by using the digital image signal to configure or program the optical collimator system to collimate light on surface 109. By using the digital image data to perform projection 122, a virtual image represented by the digital image data can be displayed in a HUD region on surface 109 as an AR object. The collimated light can be reflected by a HUD region on surface 109 to cause an operator of vehicle 101 to simultaneously view both the projected virtual images and a field of view showing real world surroundings of vehicle 101 through surface 109.

Referring to FIG. 1B, a projector 124 of projector system 120 can perform projection 122 to project virtual images in a HUD region 130 on surface 109. HUD region 130 can be designated for projecting virtual images. Since HUD region 130 is designated for projecting virtual images, projection 122 will not occur on areas of surface 109 that are outside of HUD region 130. In the example shown in FIG. 1B, HUD region 130 can include a supplemental type certificate (STC) section 132 and an AR section 134. The STC section 132 can be designated for AR objects that are compliant with STC, such as instantaneous information and/or notifications including but not limited to, speedometer indicating a current speed of vehicle 101, compass indicating traveling direction, or the like. AR section 134 can be designated for other AR objects, such as information related to navigation including directional prompts, lane assistance directions, or the like. The AR objects in AR section 134 can be in the line of sight of the operator of vehicle s101.

In the example shown in FIG. 1B, a real object 140 (e.g., a real world object such as a car) can be visible to an operator through surface 109 and HUD region 130. A STC object 150 can be projected on STC section 132 in HUD region 130, and another AR object 152 can be projected on AR section 134 in HUD region 130. STC object 150 can indicate a speed of vehicle 101, thus AR object 150 can change according to a speedometer of vehicle 101. STC object 152 can be a direction prompt, such as an arrow shape to suggest vehicle 101 to make a right turn, thus AR object 152 may not be permanently shown in AR section 134.

In an aspect, the size and brightness of the AR objects in AR section 134 can be limited to prevent impairing the vision of the operator. The HUD system formed by GPU 106, projector system 120 and surface 109 can implement fault detection to detect whether the AR objects in AR section 134 exceed these limits. If a fault condition is detected, an alert can be generated to notify the operator of vehicle or to trigger processor 102 to perform corrective actions. For example, if the fault persists, processor 102 may turn off the HUD system to prevent any further impairment to the operator's line of sight.

In an aspect, the limitations on virtual images being projected in STC section 132 can be less restrictive than the limitations on images being projected in AR section 134 due to AR section 134 being the region that is more likely to be in the operator's line of sight. The limitations on the AR objects in AR section 134 can maintain the visibility of the AR objects while minimizing the density of high luminance pixels within a bounding box of the object. To impose limitations on the AR objects in AR section 134, several attributes are imposed on the AR objects. These attributes include, but not limited to, 1) display blank background most of time, i.e. 100% transparency for the HUD combiner (e.g., HUD region 130) on the windshield when no AR object is presented; 2) an AR object is typically drawn with a single color, i.e. keep the hue near constant and adjust the luminance level accordingly; 3) most of the pixels in the AR object are medium-low luminance, the density of the bright pixels showing up in the edge of AR object or white digits is relatively low within the bounding box; and 4) the density of active pixels distributed in multiple AR objects within a frame is low.

However, these attributes do not address the challenges of concealment, which is a fault condition where a real world object is concealed or obstructed by an AR object in AR section 134. Concealment can be caused by hardware faults or software execution error in GPU 106 when generating the image data of virtual images to be projected by projector system 120. In an aspect, concealment can be indicated by: 1) High density of bright pixels distributed in one region or multiple adjacent regions within AR section 134; 2) High density of random pixels distributed in one region or multiple adjacent regions within AR section 134; 3) High count of active AR pixels randomly distributed in AR section 134. Hence, conventional systems tend to detect concealment by detecting abnormally high density of bright pixels in regions within AR section 134.

Conventional systems can implement region measurement scheme that extracts, for each region in AR section 134, the low frequency or direct current (DC) component (e.g., an average) of luminance, and compare the DC component with a threshold to detect abnormally high density of bright pixels. This regional comparison scheme of DC component can require relatively less workload, but it does not provide sufficient fault coverage. For example, the regional comparison scheme of DC component are typically performed on regions that are relatively large (e.g., more pixels), thus suffers from high quantization error and aliasing effect. The high quantization error and aliasing effect can increase false positive and false negative results, which causes concealment objects located across multiple regions to remain undetected. Reducing the size of the regions can increase the number of regions, hence increasing the number of DC component comparisons and increases workload.

To improve accuracy of concealment detection with reduced false positive and false negative results, system 100 described in the present disclosure can use additional search criteria for increasing accuracy of fault detection to decrease false positive and false negative fault detections. The additional search criteria can include individual pixel color and luminance distribution of individual regions within AR section 134, instead of using average pixels values, such as DC component. In one embodiment, system 100 can determine the pixel distribution of active areas of individual regions within AR section 134, and the determined pixel distribution can be used for detecting concealment. In an aspect, the AR objects in AR section 134 can have predefined shapes, sizes and color, such that the pixel distribution possibilities are also limited. Hence, system 100 can use the pixel distribution of stored AR objects to determine whether there are abnormal pixel distributions that indicate concealment fault conditions. For example, pixel distribution possibilities may be stored in memory 104, such as in the form of look-up table (LUT), and when a region within AR section 134 does not conform to a known pixel distribution, system 100 can determine that a fault condition, such as concealment, is detected.

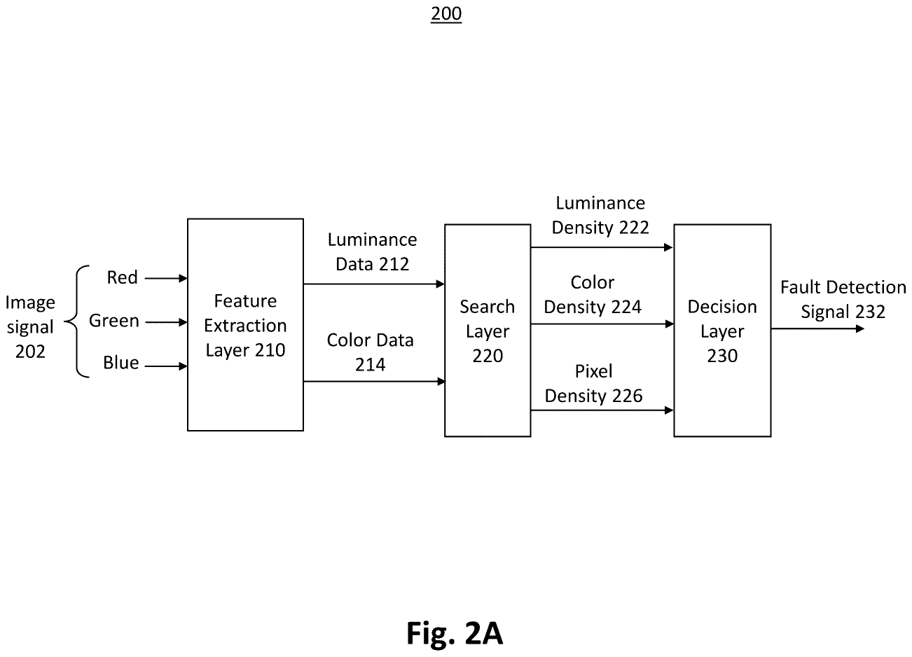

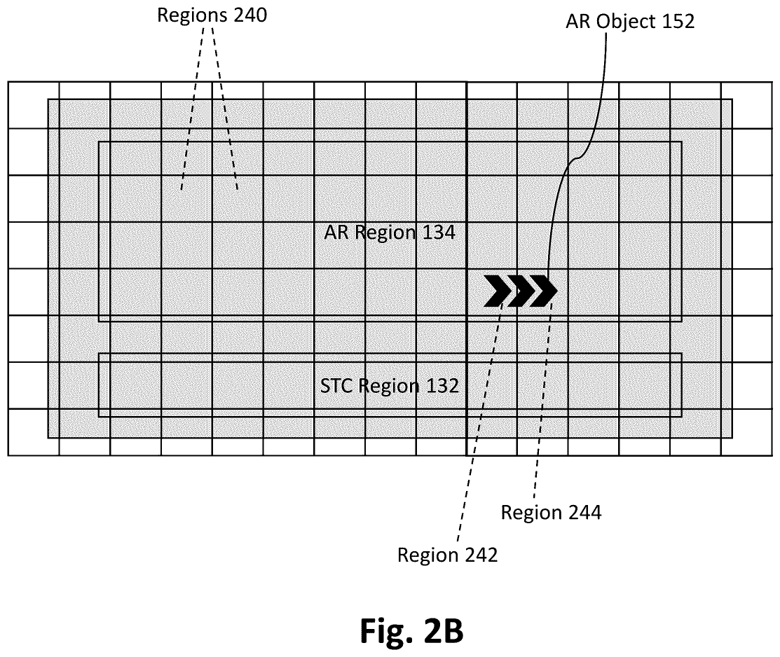

FIG. 2A is a diagram showing an example implementation of fault detection for heads-up display in one embodiment. Descriptions of FIG. 2A can reference components shown in FIG. 1A and FIG. 1B. FIG. 2A shows an implementation of a fault detection process 200. Fault detection process 200 can be performed by, for example, processor 102 of system 100. Fault detection process 200 can include a feature extraction layer 210, a search layer 220 and a decision layer 230. To begin fault detection process 200, processor 102 can receive an image signal 202 from GPU 106 and perform feature extraction layer 210. Image signal 202 can encode image data of a virtual image to be projected in HUD region 130 of surface 109. For example, image signal 202 can encode attributes of a virtual image of a directional prompt such as AR object 152. The attributes encoded in image signal 202 can include pixel values or color values of each pixel of the virtual image, such as color values representing the amount of colors red, green, blue according to the RGB color code. In one embodiment, image signal 202 can be received by processor 102 prior to the virtual image being projected in HUD region 130 of surface 109. In one embodiment, image signal 202 can be received by processor 102 without the virtual image being projected in HUD region 130 of surface 109.

Referring to FIG. 2B, HUD region 130 can be partitioned into a plurality of regions 240, where each one of regions 240 can be a group of pixels. Each region among regions 240 can be a rectangular region and the plurality of regions 240 can have identical shape and size (e.g., size can be number of pixels). Each region among regions 240 can include a plurality of blocks, such as blocks of 16×16 pixels, or 8×8 pixels. As a result of partitioning HUD region 130 into regions 240, AR objects being displayed in STC section 132 and AR section 134 can be displayed on one or more regions among regions 240. In the example shown in FIG. 2B, AR object 152 can be displayed in AR section 134 spanning from region 242 to region 244. The size and shape of regions 240 shown in FIG. 2B are for illustrative purposes, other size and shapes of regions 240 are also possible.

Processor 102 can perform feature extraction layer 210 by selecting a region, or a group of pixels, among regions 240. Processor 102 can extract or determine at least one characteristic for each pixel in the selected region. The at least one characteristic can include lumen values of the pixels and color values of the pixels in the selected region. Lumen values of the pixels can represent the luminance of the pixels, which indicates a brightness or intensity of the pixels. Processor 102 can use a predefined relationship between the color values of a pixel (e.g., R, G, and B values in RGB color code) and luminance to determine a lumen value of the pixel. Processor 102 can extract the lumen values of the pixels in the selected region, and populate a data array having a predefined array size and structure to generate luminance data 212. By way of example, if there are 256 pixels (e.g., 16×16) in the selected region, processor 102 can generate luminance data 212 by populating a 16×16 array corresponding to the selected region with the extracted lumen values. If there are N regions among regions 240 and each region include M pixels, then luminance data 212 can include N data arrays with each data array including M lumen values. In one embodiment, luminance data 212 can be the luminance density components of individual pixels in the group of pixels in the selected region.

Processor 102 can extract the color values of the pixels in the selected region and populate a data array having a predefined array size and structure to generate color data 214. By way of example, if there are 256 pixels (e.g., 16×16) in the selected region, processor 102 can generate color data 214 by populating a 16×16 array corresponding to the selected region with the extracted color values. If there are N regions among regions 240 and each region include M pixels, then luminance data 212 can include N data arrays with each data array including M color values. Processor 102 can determine luminance data 212 and color data 214 for each region among regions 240. Processor 102 can select the regions sequentially in a predefined order to determine the corresponding luminance data 212 and color data 214. In one embodiment, color data 214 can be the color density components of individual pixels in the group of pixels in the selected region.

Luminance data 212 and color data 214 can be provided to the search layer 220. Processor 102 can perform search layer 220 to determine one or more group attributes representative of the group of pixels, or the selected region, based on the at least one characteristic determined for each pixel in the selected region. In one embodiment, the one or more group attributes can include statistical distributions of the at least characteristic values. By way of example, the one or more group attributes can include histograms representing density distributions of the lumen values and/or color values extracted by processor 102 in feature extraction layer 210. In one embodiment, the determination of the density distributions can include binning the extracted lumen values and/or color values in a plurality of ranges to generate histograms for the selected region. In one embodiment, the binning performed by processor 102 can derive AC components of the luminance of the pixels among regions 240. By way of example, the binning can implement an application of a high pass filter on the pixels in the selected region to obtain binary results, such as mapping the pixel lumen values to binary values to generate a two-dimensional map that reflects the AC components of the pixel lumen values. Processor 102 can generate a histogram for the lumen values, and another histogram for the color values. The search layer 220 can include processor 102 using a sliding window to search through the extracted lumen values and/or color values, region to region, to identify and classify the lumen values and/or color values into different ranges of the histograms. Processor 102 can output the histograms of lumen values as luminance density 222, and can output the histograms of color values as color density 224, to decision layer 230.

In another embodiment, the one or more group attributes can include pixel density 226. Pixel density 226 can be, for example, a density of pixels with the at least one characteristic being greater than a predefined threshold. For example, if the at least one characteristic is lumen value, the pixel density 226 can indicate a density of pixels in the selected region having lumen values that exceed a predefined threshold lumen value, where the predefined threshold lumen value can be stored in memory 104. If the at least one characteristic is color value, the pixel density 226 can indicate a density of pixels in the selected region having color values that exceed a predefined threshold color value, where the predefined threshold color value can be stored in memory 104. Processor 102 can determine the pixel density 226 for each region among regions 240 and output pixel density 226 of regions 240 to decision layer 230.

In another embodiment, the one or more group attributes can include distribution patterns of density, such as distribution patterns of various spatial density including luminance density 222, color density 224, pixel density 226, or other types of spatial density. At decision layer 230, processor 102 can determine whether the one or more group attributes satisfies a set of predefined threshold group attributes or not. In one embodiment, if the lumen value distribution indicated by luminance density 222 of a selected region is the same as a predefined lumen value distribution for the corresponding region of the virtual image, then processor 102 can determine that the lumen value distribution indicated by luminance density 222 satisfies the predefined lumen value distribution. If the lumen value distribution indicated by luminance density 222 of a selected region is different from the predefined lumen value distribution for the corresponding region of the virtual image, then processor 102 can determine that the lumen value distribution indicated by luminance density 222 fails to satisfy the predefined lumen value distribution.

In another embodiment, if the color value distribution indicated by color density 224 of a selected region is the same as a predefined color value distribution for the corresponding region of the virtual image, then processor 102 can determine that the color value distribution indicated by color density 224 satisfies the predefined color value distribution. If the color value distribution indicated by luminance density 222 of a selected region is different from the predefined color value distribution for the corresponding region of the virtual image, then processor 102 can determine that the color value distribution indicated by luminance density 222 fails to satisfy the predefined color value distribution.

In another embodiment, if a number of pixels having lumen values exceeding a predefined threshold lumen pixel density, which is indicated in pixel density 226, is less than a predefined pixel density for the selected region, then processor 102 can determine that the pixel density 226 satisfies the predefined pixel density for the selected region. If the number of pixels having lumen values exceeding a predefined threshold lumen pixel density, which is indicated in pixel density 226, is greater than the predefined pixel density for the selected region, then processor 102 can determine that the pixel density 226 fails to satisfy the predefined pixel density for the selected region.

If processor 102 determines that the one or more group attributes fails to satisfy the set of predefined threshold group attributes, processor 102 can output a fault detection signal 232. In one embodiment, processor 102 can output the fault detection signal 232 as a visual indicator on a display (e.g., infotainment screen or telltale indicator) to notify the operator of vehicle 101 that there are fault conditions in the HUD system formed by GPU 106, projector system 120 and surface 109. In another embodiment, processor 102 can output the fault detection signal 232 as an internal signal (e.g., internal to processor 102) and processor 102 can perform various actions to address the fault condition. In one embodiment, processor 102 can determine a frequency of the detected fault condition. If the fault condition persists for over a predetermined amount of time, or occurs at a number of times greater than a predetermined number of times, or occurs at a frequency greater than a predetermined frequency of occurrence, then processor 102 can disable the HUD system.

In another embodiment, fault detection signal 232 can indicate a hardware fault. By way of example, a plurality of registers or memory devices among memory 104 can store pixel values of a virtual image to be projected in projection 122. If a register is corrupted, the pixel value stored in the corrupted register can be incorrect and cause the virtual image being projected to be distorted. Thus, fault detection signal 232 can indicate that there is a hardware fault, such as corrupted registers or corrupted memory devices. The fault detection process 200 can be performed by system 100 to identify hardware faults without a user, such as operator of vehicle 101, to visually identify errors in HUD region 130 of surface 109.

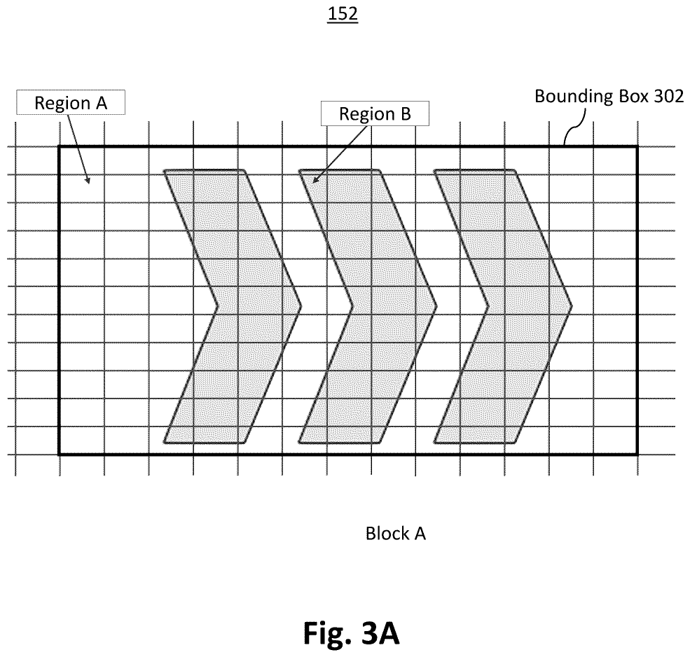

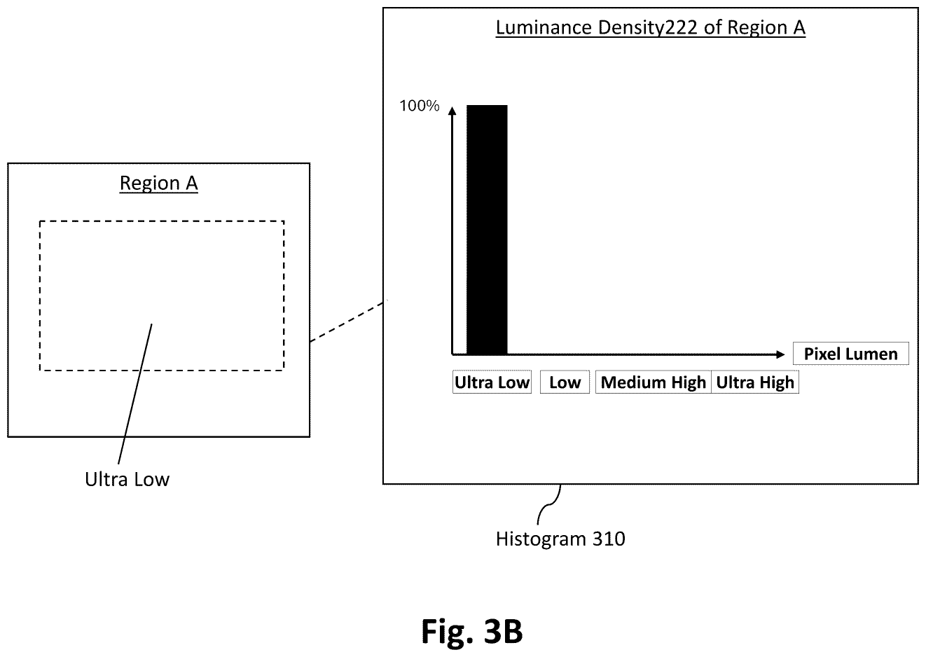

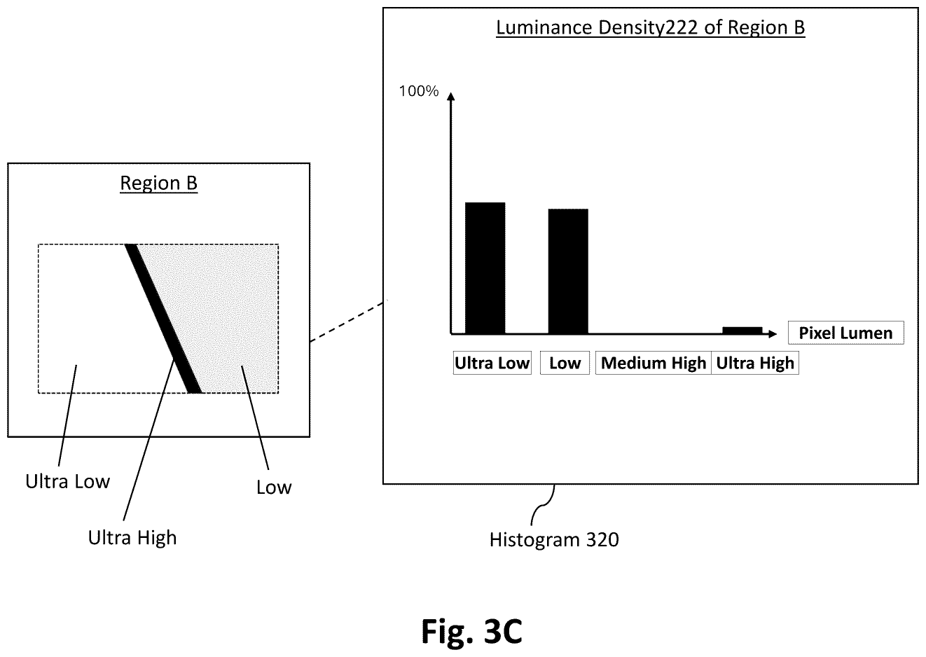

FIG. 3A is a diagram showing a plurality of regions of an example augmented reality object that can be used in an implementation of fault detection for heads-up display in one embodiment. Descriptions of FIG. 3A can reference components shown in FIG. 1A to FIG. 2B. In an example shown in FIG. 3A, the AR object 152 can be displayed within a bounding box 302 and span across multiple regions, including region A and region B, among regions 240. Bounding box 302 can be predefined for displaying AR object 152 at a specific location in HUD region 130. Coordinates defining bounding box 302 can be stored in memory 104. The unshaded portions in bounding box 302 are regions where no image is being projected, and the shaded portions are areas in bounding box 302 where at least one pixel of a virtual image is being projected. Region A is a region where no pixels are projected and region B is a region where at least one pixel is projected.

Referring to FIG. 3B and using region A as an example, in feature extraction layer 210, processor 102 can extract lumen values of all pixels in region A. Processor 102 can perform search layer 220, such as by using a sliding window across lumen values of region A, to read the extract lumen values and bin the extracted lumen values. Binning the extracted lumen values can include classifying or distributing the extracted lumen values into different ranges of lumen values to generate a histogram 310 for region A. As shown by histogram 310, the range of lumen values for binning can be categorized into four ranges - Ultra Low, Low, Medium High and Ultra High. Although four ranges are shown in the examples in the present disclosure, other numbers of ranges are also possible. Since region A does not have any projected pixels, 100% of the pixels are classified by processor 102 into the Ultra Low range of lumen values.

Processor 102 can send histogram 310 to the decision layer 230. In decision layer 230, processor 102 can compare histogram 310 with a stored histogram for region A corresponding to AR object 152. If the stored histogram also has 100% of pixels in the Ultra Low range, then processor 102 can determine that there are no errors in region A. If the stored histogram does not have 100% of pixels in the Ultra Low range, then processor 102 can determine that there may be errors in region A and output fault detection signal 232.

In one embodiment, a sensitivity of the comparison can be adjusted. For example, if processor 102 performs decision layer 230 under a predefined error tolerance of 1%, which is relatively high sensitivity, the stored histogram having 99% of pixels in the Ultra Low range and 1% of pixels on other ranges would trigger processor 102 to determine there is an error. If the sensitivity is lowered, such as setting the predefined error tolerance to 5%, then the stored histogram having 99% of pixels in the Ultra Low range and 1% of pixels on other ranges would not trigger processor 102 to determine there is an error. Instead, the stored histogram having 95% pixels in the Ultra Low range and 5% of pixels on other ranges would trigger processor 102 to determine there is an error.

Referring to FIG. 3C and using region B as an example, in feature extraction layer 210, processor 102 can extract lumen values of all pixels in region B. Processor 102 can perform search layer 220, such as by using a sliding window across lumen values of region B, to read the extract lumen values and bin the extracted lumen values. Binning the extracted lumen values can include classifying or distributing the extracted lumen values into different ranges of lumen values to generate a histogram 320 for region B. As shown by histogram 320, since region B has pixels in different lumen value ranges, the luminance density distribution of region B has bins in different ranges of lumen values. For example, approximately 50% of the pixels are classified as Ultra Low (e.g., the white or unshaded portion), approximately 45% of the pixels are classified as Low (e.g., the portion shaded in gray), and approximately 5% of the pixels are classified as Ultra High (e.g., the black line).

In one embodiment, processor 102 can also determine that there is an error if pixels that projected Medium High and Ultra High lumens accounted for more than a predefined percentage, such as 15%, of the entire region, as medium high and ultra-high lumen pixels are typically used as shape boundaries instead of an interior of the AR object.

Processor 102 can send histogram 320 to the decision layer 230. In decision layer 230, processor 102 can compare histogram 320 with a stored histogram for region B corresponding to AR object 152. If the stored histogram has the same, or similar, distribution within the predefined error tolerance level, then processor 102 can determine that there are no errors in region B. If the stored histogram has different or a distribution outside of the predefined error tolerance level, then processor 102 can determine that there may be errors in region B and output fault detection signal 232.

Processor 102 can perform the generation of histogram and comparison with stored histograms for every region within bounding box 302. In one embodiment, if at least one region has an error, processor 102 can determine that the entire AR object 152 being displayed from projection 122 is erroneous. By way of example, if there is an error in region A, which is supposed to be transparent with no pixels projected, then there may be undesirable pixels within bounding box 302 that can conceal real world objects. If there is an error in region B, such as extra pixels with Ultra High lumen values then the shape of AR object 152 can be distorted and the extra high lumen pixels can conceal real world objects.

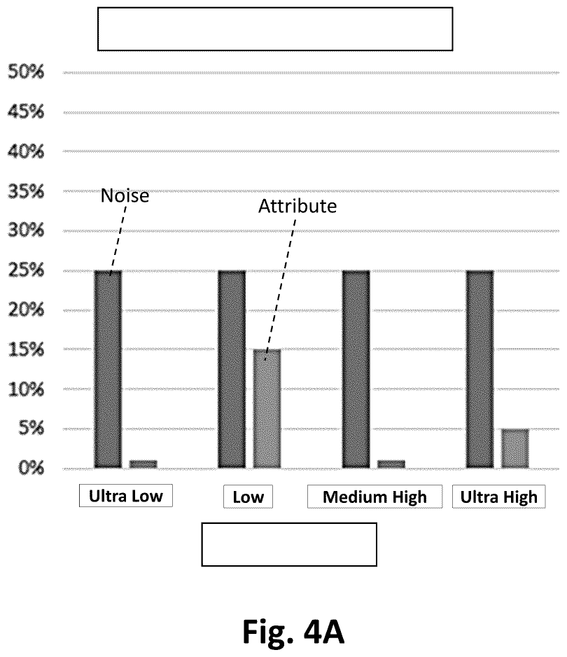

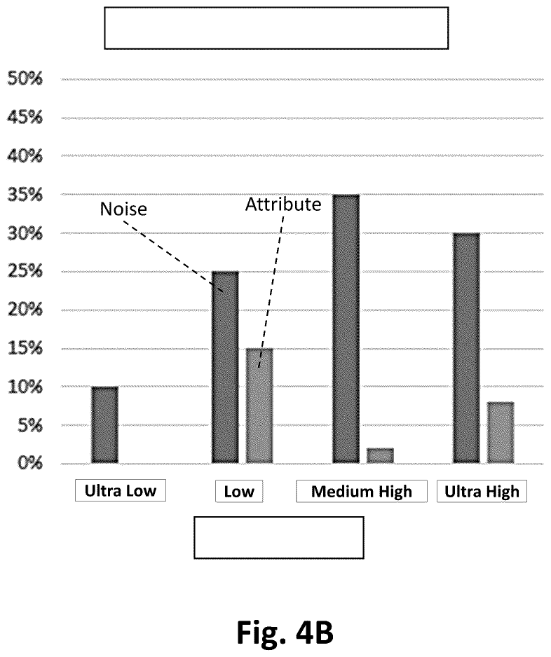

FIG. 4A is a diagram showing a probability distribution of pixels before an equalization in an implementation of fault detection for heads-up display in one embodiment. Descriptions of FIG. 4A can reference components shown in FIG. 1A to FIG. 3C. In one embodiment, processor 102 can perform equalization to reduce the impact of noise and improve the performance of fault detection process 200. Processor 102 can perform equalization by pre-processing the pixels, or the pixel values for each pixel, among image signal 202 before performing the feature extraction layer 210. The equalization can be also performed at other layers such as search layer 220 or decision layer 230. Processor 102 can perform the equalization by amplifying the in-band noise of image signal 202 (or a selected region of pixels) in order to increase the energy of image signal 202 (or a selected region of pixels). The energy of image signal 202 (or a selected region of pixels) can be the intensity of the pixel values (e.g., such as attributes including luminance or color) in image signal 202 (or a selected region of pixels). The increase in energy can cause a distribution, such as luminance distribution or color distribution, to have higher density towards higher luminance range (e.g., Medium High and Ultra High).

Referring to FIG. 4A, a distribution of a group of pixels before equalization of the in-band noise of image signal 202 is shown. Without equalization, the in-band noise of image signal 202 has a uniform distribution, as shown by the noise distribution being uniformed at 25% across all attribute ranges. To perform equalization, the uniform distribution of the noise shown FIG. 4A will be adjusted to boost the attribute in the Medium High and Ultra High ranges. Referring to FIG. 4B, the noise distribution is adjusted to a non-uniform distribution. For example, the noise at the Ultra Low range is lowered from 25% to 10%, the noise at the Low range remains at 25%, the noise at the Medium High range is increased, or amplified, from 25% to 35%, and the noise at the Ultra High range is increased, or amplified, from 25% to 30%. The equalization of noise causes the attribute at Ultra Low range to reduce to zero, and boosted the attribute at Medium High and Ultra high ranges. With the increased attribute at Medium High and Ultra high ranges, the concealment can be more easily detected since concealment fault detection is based on the distribution of pixels classified into the Medium High and Ultra high ranges, as mentioned in the present disclosure.

In one embodiment, the equalization to adjust the noise distribution can be dependent on the AR image corresponding to image signal 202, or the selected region being processed by processor 102. By way of example, processor 102 can perform equalization in decision layer 230 based on pixel density 226. If pixel density 226 indicates that a relatively small number of pixels in the selected region have lumen values exceeding the predefined threshold lumen value, then processor 102 can perform an equalization to increase the number of pixels in the Medium High and Ultra High range to increase a possibility of detecting concealment.

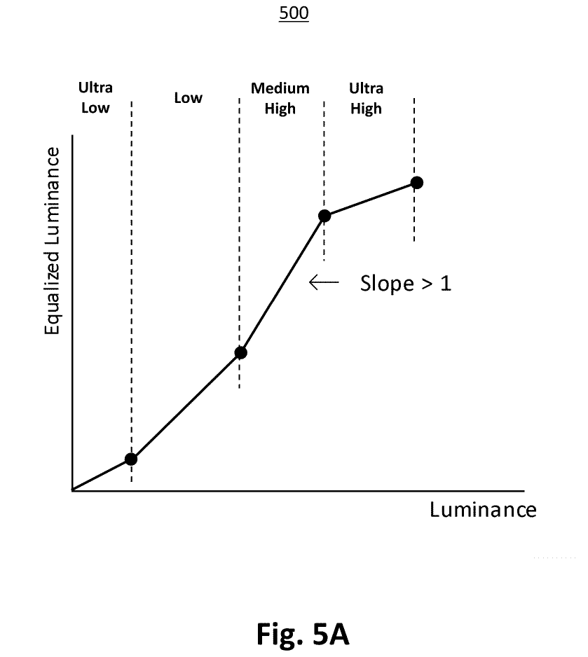

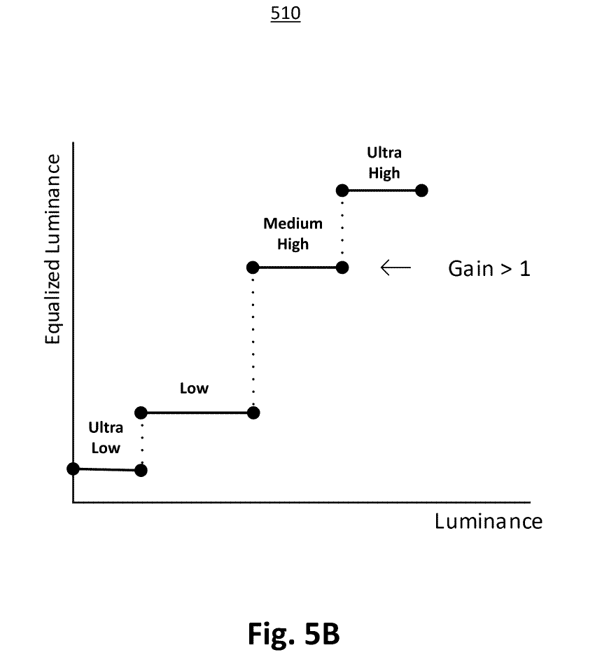

FIG. 5A is a diagram showing a first example equalization that can be used in an implementation of fault detection for heads-up display in one embodiment. Descriptions of FIG. 5A can reference components shown in FIG. 1A to FIG. 4B. A piece-wise linear transfer function 500 is shown in FIG. 5A. Processor 102 can apply piece-wise linear transfer function 500 to adjust the in-band noise of image signal 202. The piece-wise linear transfer function 500 can allow processor 102 to adjust the in-band noise based on different attribute ranges, such as luminance ranges. In the example shown in FIG. 5A, luminance of pixels having Medium High luminance can be amplified the most when compared to other ranges, as evident by the steepest slope in piece-wise linear transfer function 500. Luminance of pixels having Ultra Low luminance can be amplified the least, or even decreased, when compared to other ranges, as evident by the flattest slope in piece-wise linear transfer function 500.

FIG. 5B is a diagram showing a second example equalization that can be used in an implementation of fault detection for heads-up display in one embodiment. Descriptions of FIG. 5B can reference components shown in FIG. 1A to FIG. 4B. A boxcar filter 510 is shown in FIG. 5B. Processor 102 can apply boxcar filter 510 to adjust the in-band noise of image signal 202. The boxcar filter 510 can allow processor 102 to adjust the in-band noise based on different attribute ranges, such as luminance ranges. In the example shown in FIG. 5B, luminance of pixels having Medium High luminance can be amplified the most when compared to other ranges, as evident by the greatest increase along the y-axis in boxcar filter 510. Luminance of pixels having Ultra Low luminance can be amplified the least, or even decreased, when compared to other ranges, as evident by the least increase along the y-axis in boxcar filter 510.

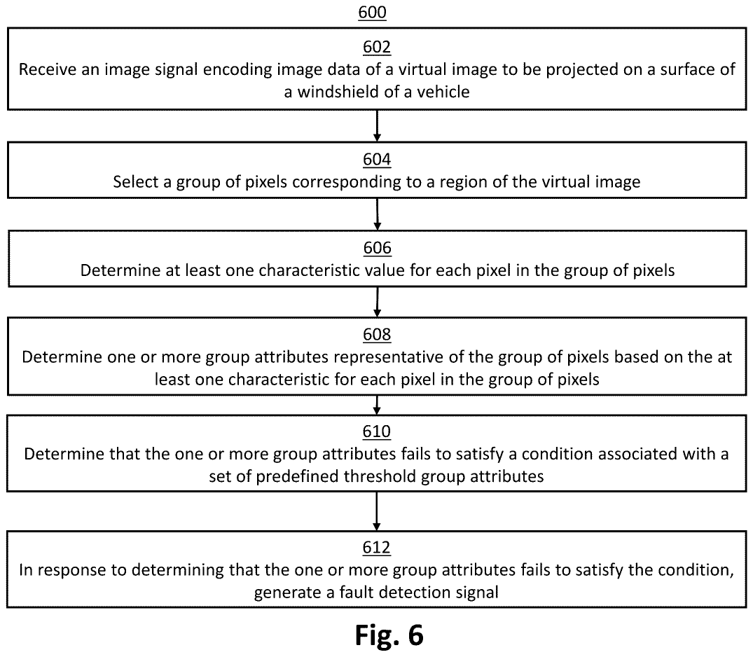

FIG. 6 is a flowchart of an example process that can implement fault detection for heads-up display in one embodiment. Process 600 can include one or more operations, actions, or functions as illustrated by one or more of blocks 602, 604, 606, 608, 610 and/or 612. Although illustrated as discrete blocks, various blocks can be divided into additional blocks, combined into fewer blocks, eliminated, performed in different order, or performed in parallel, depending on the desired implementation.

Process 600 can be performed by a computing system in a vehicle, such as system 100 described in the present disclosure, to perform fault detection in heads-up display. Process 600 can begin at block 602. At block 602, a processor can receive an image signal encoding image data of a virtual image to be projected on a surface of a windshield of a vehicle. Process 600 can proceed from block 602 to block 604. At block 604, the processor can select a group of pixels corresponding to a region of the virtual image. Process 600 can proceed from block 604 to block 606. At block 606, the processor can determine at least one characteristic for each pixel in the group of pixels. In one embodiment, the at least one characteristic value can be one of a luminance value of a pixel and a color value of a pixel.

Process 600 can proceed from block 606 to block 608. At block 608, the processor can determine one or more group attributes representative of the group of pixels based on the at least one characteristic for each pixel in the group of pixels. In one embodiment, the one or more group attributes comprises a statistical distribution of the at least one characteristic value, and determining the one or more group attributes for the group of pixels can include binning the at least one characteristic value in a plurality of ranges to generate a histogram corresponding to the group of pixels. In one embodiment, the one or more group attributes an include a spatial density of pixels with the at least one characteristic value being greater than a predefined threshold. In one embodiment, the spatial density of pixels can be one of a pixel density, a luminance density and a color density.

Process 600 can proceed from block 608 to block 610. At block 610, the processor can determine that the one or more group attributes fails to satisfy a condition associated with a set of predefined threshold group attributes. Process 600 can proceed from block 610 to block 612. At block 612, the processor can, in response to determining that the one or more group attributes fails to satisfy the condition, generate a fault detection signal.

In one embodiment, the processor can amplify in-band noise in the group of pixels prior to determining the at least one characteristic for each pixel in the group of pixels. In one embodiment, amplifying the in-band noise is based on a statistical distribution of pixels in the group of pixels with a luminance value greater than a predefined threshold. In one embodiment, amplifying the in-band noise can include applying, by the processor, one of a piece-wise linear transfer function and a boxcar filter on the image signal.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Examples

Example 1: A computer-implemented method for fault detection in heads-up display systems, the method comprising: receiving, by a processor, an image signal encoding image data of a virtual image to be projected on a surface of a windshield of a vehicle; selecting, by the processor, a group of pixels corresponding to a region of the virtual image; determining, by the processor, at least one characteristic for each pixel in the group of pixels; determining, by the processor, one or more group attributes representative of the group of pixels based on the at least one characteristic for each pixel in the group of pixels; determining, by the processor, that the one or more group attributes fails to satisfy a condition associated with a set of predefined threshold group attributes; and in response to determining that the one or more group attributes fails to satisfy the condition, generating, by the processor, a fault detection signal.

Example 2: The method of Example 1, wherein: the one or more group attributes comprises a statistical distribution of the at least one characteristic value; and determining the one or more group attributes for the group of pixels comprises binning the at least one characteristic value in a plurality of ranges to generate a histogram corresponding to the group of pixels.

Example 3: The method of any one of Examples 1 and 2, wherein the at least one

characteristic value is one of a luminance value of a pixel and a color value of a pixel.

Example 4: The method of any one of Examples 1 to 3, wherein the one or more group attributes comprises a spatial density of pixels with the at least one characteristic value being greater than a predefined threshold.

Example 5: The method of any one of Examples 1 to 4, wherein the spatial density of pixels is one of: a pixel density; a luminance density; and a color density.

Example 6: The method of any one of Examples 1 to 5, further comprising amplifying in-band noise in the group of pixels prior to determining the at least one characteristic for each pixel in the group of pixels.

Example 7: The method of any one of Examples 1 to 6, wherein amplifying the in-band noise is based on a statistical distribution of pixels in the group of pixels with a luminance value greater than a predefined threshold.

Example 8: The method of any one of Examples 1 to 7, wherein amplifying the in-band noise comprises applying, by the processor, one of a piece-wise linear transfer function and a boxcar filter on the image signal.

Example 9: A system comprising: a memory configured to store a condition associated with a set of predefined threshold group attributes; and a processor configured to: receive an image signal encoding image data of a virtual image to be projected on a surface of a windshield of a vehicle; select a group of pixels from the image signal; determine at least one characteristic for each pixel in the group of pixels; determine one or more group attributes representative of the group of pixels based on the at least one characteristic for each pixel in the group of pixels; determine whether the one or more group attributes satisfy a condition associated with a set of predefined threshold group attributes; and in response to determination that the one or more group attributes fails to satisfy the condition, generate a fault detection signal.

Example 10: The system of Example 9, wherein: the one or more group attributes comprises a statistical distribution of the at least one characteristic value; and the processor is configured to determine the one or more group attributes for the group of pixels comprises binning the at least one characteristic value in a plurality of ranges to generate a histogram corresponding to the group of pixels.

Example 11: The system of any one of Examples 9 and 10, wherein the at least one characteristic value is one of a luminance value of a pixel and a color value of a pixel.

Example 12: The system of any one of Examples 9 to 11, wherein the one or more group attributes comprises a spatial density of pixels with the at least one characteristic value being greater than a predefined threshold.

Example 13: The system of any one of Examples 9 to 12, wherein the spatial density of pixels is one of: a pixel density; a luminance density; and a color density.

Example 14: The system of any one of Examples 9 to 13, wherein the processor is configured to amplify in-band noise in the group of pixels prior to determining the at least one characteristic for each pixel in the group of pixels.

Example 15: A system comprising: a graphic processing unit (GPU) configured to generate image signal encoding image data of a virtual image; a surface; a projector configured to project the virtual image on the surface; and a processor configured to: receive the image signal from the GPU; select a group of pixels from the image signal; determine at least one characteristic for each pixel in the group of pixels; determine one or more group attributes representative of the group of pixels based on the at least one characteristic for each pixel in the group of pixels; determine whether the one or more group attributes satisfy a condition associated with a set of predefined threshold group attributes; and in response to determination that the one or more group attributes fails to satisfy the condition, generate a fault detection signal.

Example 16: The system of Example 15, wherein: the one or more group attributes comprises a statistical distribution of the at least one characteristic value; and the processor is configured to determine the one or more group attributes for the group of pixels comprises binning the at least one characteristic value in a plurality of ranges to generate a histogram corresponding to the group of pixels.

Example 17: The system of any one of Examples 15 and 16, wherein the at least one characteristic value is one of a luminance value of a pixel and a color value of a pixel.

Example 18: The system of any one of Examples 15 to 17, wherein: the one or more group attributes comprises a spatial density of pixels with the at least one characteristic value being greater than a predefined threshold; and the spatial density of pixels is one of: a pixel density; a luminance density; and a color density.

Example 19: The system of any one of Examples 15 to 18, wherein the processor is configured to amplify in-band noise in the group of pixels prior to determining the at least one characteristic for each pixel in the group of pixels.

Example 20: A vehicle comprising the system recited in any one of Examples 15 to 19.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present disclosure have been presented for purposes of illustration and description but are not intended to be exhaustive or limited to the present disclosure in the forms disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

What is claimed is:

1. A computer-implemented method for fault detection in heads-up display systems, the method comprising:
receiving, by a processor, an image signal encoding image data of a virtual image to be projected on a surface of a windshield of a vehicle;
selecting, by the processor, a group of pixels corresponding to a region of the virtual image;
determining, by the processor, at least one characteristic value for each pixel in the group of pixels;
determining, by the processor, one or more group attributes representative of the group of pixels based on the at least one characteristic for each pixel in the group of pixels;
determining, by the processor, that the one or more group attributes fails to satisfy a condition associated with a set of predefined threshold group attributes; and
in response to determining that the one or more group attributes fails to satisfy the condition, generating, by the processor, a fault detection signal.

2. The computer-implemented method of claim 1, wherein:
the one or more group attributes comprises a statistical distribution of the at least one characteristic value; and
determining the one or more group attributes for the group of pixels comprises binning the at least one characteristic value in a plurality of ranges to generate a histogram corresponding to the group of pixels.

3. The computer-implemented method of claim 1, wherein the at least one characteristic value is one of a luminance value of a pixel and a color value of a pixel.

4. The computer-implemented method of claim 1, wherein the one or more group attributes comprises a spatial density of pixels with the at least one characteristic value being greater than a predefined threshold.

5. The computer-implemented method of claim 4, wherein the spatial density of pixels is one of:
a pixel density;
a luminance density; and
a color density.

6. The computer-implemented method of claim 1, further comprising amplifying in-band noise in the group of pixels prior to determining the at least one characteristic for each pixel in the group of pixels.

7. The computer-implemented method of claim 6, wherein amplifying the in-band noise is based on a statistical distribution of pixels in the group of pixels with a luminance value greater than a predefined threshold.

8. The computer-implemented method of claim 6, wherein amplifying the in-band noise comprises applying, by the processor, one of a piece-wise linear transfer function and a boxcar filter on the image signal.

9. A system comprising:
a memory configured to store a condition associated with a set of predefined threshold group attributes; and
a processor configured to:
receive an image signal encoding image data of a virtual image to be projected on a surface of a windshield of a vehicle;
select a group of pixels from the image signal;
determine at least one characteristic value for each pixel in the group of pixels;
determine one or more group attributes representative of the group of pixels based on the at least one characteristic for each pixel in the group of pixels;
determine whether the one or more group attributes satisfy a condition associated with a set of predefined threshold group attributes; and
in response to determination that the one or more group attributes fails to satisfy the condition, generate a fault detection signal.

10. The system of claim 9, wherein:
the one or more group attributes comprises a statistical distribution of the at least one characteristic value; and
the processor is configured to determine the one or more group attributes for the group of pixels comprises binning the at least one characteristic value in a plurality of ranges to generate a histogram corresponding to the group of pixels.

11. The system of claim 9, wherein the at least one characteristic value is one of a luminance value of a pixel and a color value of a pixel.

12. The system of claim 9, wherein the one or more group attributes comprises a spatial density of pixels with the at least one characteristic value being greater than a predefined threshold.

13. The system of claim 12, wherein the spatial density of pixels is one of:
a pixel density;
a luminance density; and
a color density.

14. The system of claim 9, wherein the processor is configured to amplify in-band noise in the group of pixels prior to determining the at least one characteristic for each pixel in the group of pixels.

15. A system comprising:
a graphic processing unit (GPU) configured to generate an image signal encoding image data of a virtual image;
a surface;
a projector configured to project the virtual image on the surface; and
a processor configured to:
receive the image signal from the GPU;
select a group of pixels from the image signal;
determine at least one characteristic value for each pixel in the group of pixels;
determine one or more group attributes representative of the group of pixels based on the at least one characteristic for each pixel in the group of pixels;
determine whether the one or more group attributes satisfy a condition associated with a set of predefined threshold group attributes; and
in response to determination that the one or more group attributes fails to satisfy the condition, generate a fault detection signal.

16. The system of claim 15, wherein:
the one or more group attributes comprises a statistical distribution of the at least one characteristic value; and
the processor is configured to determine the one or more group attributes for the group of pixels comprises binning the at least one characteristic value in a plurality of ranges to generate a histogram corresponding to the group of pixels.

17. The system of claim 15, wherein the at least one characteristic value is one of a luminance value of a pixel and a color value of a pixel.

18. The system of claim 15, wherein:
the one or more group attributes comprises a spatial density of pixels with the at least one characteristic value being greater than a predefined threshold; and
the spatial density of pixels is one of:
a pixel density;
a luminance density; and
a color density.

19. The system of claim 15, wherein the processor is configured to amplify in-band noise in the group of pixels prior to determining the at least one characteristic for each pixel in the group of pixels.

20. A vehicle comprising the system recited in claim 15.
